(19) United States
(12) Patent Application Publication
(10) Pub. No.: US 2003/0046571 A1
(43) Pub. Date: Mar. 6, 2003

(54) Self-decoding type encrypted file and its utilization method

(76) Inventor: Keisuke Nakayama, Tokyo (JP)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/229,106

(22) Filed: Aug. 28, 2002

(30) Foreign Application Priority Data
Aug. 31, 2001 (JP) P.2001-263844

(51) Int. Cl. G06F 12/14

(52) U.S. Cl. 713/193

(57) ABSTRACT

The present invention provides a self-decoding type encrypted file which can be decoded with encrypted data received from a transmitting side even when a receiving side has no decoding software, and its utilization method. According to the self-decoding type encrypted file and the utilization method thereof, the self-decoding type encrypted file is generated which integrally retains a decoding execution program for decoding the encrypted information together with encrypted data; the file is transmitted from a transmitting side PC; and on a receiving side PC, legal personal identification information is entered, whereby the encrypted data associated with the self-decoding execution program is decoded to extract data. Therefore, even when a decoding program is not installed in the receiving side PC, the encrypted data can be decoded by the self-decoding execution program retained integrally with the encrypted information.

### BACKGROUND OF THE INVENTION

1. Field of the Invention

The present invention relates to a self-decoding type encrypted file containing a program for decoding retained encrypted data, and more particularly to a self-decoding type encrypted file having a self-decoding execution program to perform self-decoding of integrally retained encrypted data, and its utilization method.

2. Description of the Related Art

There are various encryption and decoding systems.

Here, reference will be made to transfer of conventional general encrypted data (encrypted data).

First, it is necessary for a source (transmitting side) to encrypt data with a specific encryption key by using encryption software. The source attaches the encrypted data to an electronic mail and sends it to a destination (receiving side). The destination decodes the encrypted data attached to the received electronic mail with a decoding key corresponding to the above encryption key while using decoding software corresponding to the encryption software used by the source.

It is to be noted that as a conventional encryption and decoding technology, there is “User Mutual Authentication System, Client Device, and Server Device”, U.S. Pat. No. 3,278,612 (Patentees: NEC Corporation, Kyushu NEC Software Co., Ltd., Inventor: Atsumasa Yoshida and Ako Mishio).

However, the conventional encryption and decoding technology has required that the receiver side always installs the licensed decoding software, so that the encrypted data cannot be sent to a person who has not been licensed to the encryption software, which is inconvenient to both transmitting and receiving sides.

If the receiving side is required to equip all of decoding software of the transmitting side, the receiving side must bear considerable burden in terms of costs and troubles.

### SUMMARY OF THE INVENTION

The present invention has been developed in consideration of the above situation and is intended to provide the self-decoding type encrypted file that can be decoded with the encrypted data received from the transmitting side even when the receiving side has no decoding software, and its utilization method.

A first aspect of the present invention is directed to a self-decoding encrypted file for integrally retaining a decoding execution program for decoding associated encrypted information and the encrypted information, wherein when an operation of opening the file is done, the entry of personal identification information is demanded, and when the legal personal identification information is entered in response to the demand, the decoding execution program decodes the associated encrypted information. Therefore, even when a decoding program is not installed in a device, the encrypted information can be decoded by executing, based on the personal identification information, the decoding execution program retained integrally with the encrypted information. Accordingly, the decoding of the encrypted information can easily be performed, which makes it possible to improve convenience.

Furthermore, a second aspect of the present invention is directed to a utilization method of a self-decoding type encrypted file comprising the steps of encrypting information by a transmitting side device to generate a self-decoding encrypted file integrally retaining the thus encrypted information and a decoding execution program for decoding the encrypted information; transmitting the file; performing an operation of opening the received self-decoding type encrypted file by a receiving side device to demand the entry of personal identification information; and entering the personal identification information to decode the encrypted information in accordance with the decoding execution program and to extract the information. Therefore, even when a decoding program is not installed in the receiving side device, the decoding execution program retained integrally with the encrypted information can be executed by the use of the personal identification information to decode the encrypted information. Accordingly, the decoding of the encrypted information can easily be performed, which makes it possible to improve convenience.

### BRIEF DESCRIPTION OF THE DRAWINGS

FIG. 1 shows a schematic view showing the outline of a self-decoding type encrypted file use condition according to an embodiment of the present invention.

FIG. 2 shows a flow chart showing processing in the control of sending PC.

FIG. 3 shows a flow chart showing processing in the control of receiving PC.

<Description of Reference Numerals>

1—Sending PC 2—Receiving PC

### DESCRIPTION OF THE PREFERRED EMBODIMENT

An embodiment of the present invention will be described with reference to the attached drawings.

In a self-decoding encrypted file and its utilization method regarding embodiments of the present invention, the self-decoding type encrypted file in which a self-decoding execution program for decoding encrypted information is integrally retained with the encrypted information is generated, and the file is then sent from a transmitting side device. On a receiving side device, legal personal identification information is entered, whereby the encrypted information associated with the self-decoding execution program is decoded to extract information. Therefore, even when a decoding program is not installed in the receiving side device, the encrypted information can be decoded by the self-decoding execution program retained integrally with the encrypted information. Accordingly, the decoding of the encrypted information can easily be performed, which makes it possible to improve convenience.

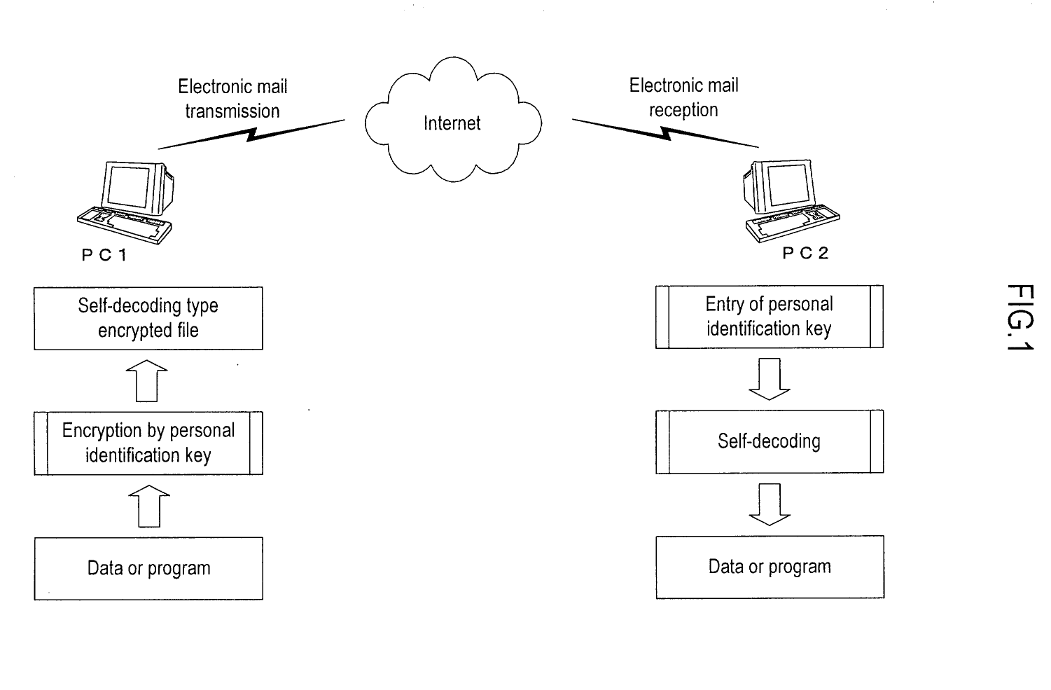

A self-decoding type encrypted file according to the embodiment of the present invention is described with reference made to FIG. 1. FIG. 1 shows schematically the outline of use of self-decoding type encrypted file according to the embodiment of the present invention.

As shown in FIG. 1, the use of the self-decoding type encrypted file (the main file) according to the embodiment of the present invention consists of a personal computer (PC) 1 (transmitting side device) on the source (transmitting side) and a personal computer (PC) 2 (receiving side device) on the destination (receiving side), and both PC are connected via Internet with wire or wireless.

Here, the transmitting and receiving side devices are considered to be PCs, but PDA and other information terminals may be used. PHS and cellular phone may also be used provided that the encryption and decoding program can operate thereon.

A transmitting side PC1 has a licensed encryption and decoding program installed while having a program (self-decoding execution program) to self-decode encrypted data (encrypted information or encryption data).

A transmitting side PC1 also selects at a time of data encryption whether simple encrypted data is generated or a self-decoding type encrypted file in which the encrypted data is integral with the self-decoding execution program is generated.

A self-decoding type encrypted file is a module (self-decoding type module) of execution file type (EXE file). When generated, the self-decoding type encrypted file is associated with identified encrypted data for decoding and performs decoding of the specified (integrated) encrypted data only during self-decoding on a receiving PC2 side.

It is to be noted that encryption and decoding are performed by the use of a specific personal identification key (personal identification information).

Additionally, it is to be noted that that the encryption may be performed not only for the data but also for a macro or a program.

Furthermore, a transmitting side PC1 has an electronic mail function and transmits the generated self-decoding type encrypted file with an attached file of an electronic mail to the destination (receiving side) PC2.

A receiving side PC2 has an electronic mail function, and when an electronic mail having an attached self-decoding type encrypted file is received, the self-decoding type encrypted file is double clicked to open the file, whereby the execution of a self-decoding module which is an execution file (EXE file) is started. First, a pop-up window for demanding the entry of a personal identification key is displayed, and the personal identification key is then entered on the receiving side. The personal identification key may beforehand be informed via telephone or mail from the transmitting side.

When a legal personal identification key is entered, a self-decoding execution program in a self-decoding type encrypted file runs on the memory of PC2 to decodes the specific associated encrypted data. At completion of data decoding, the self-decoding execution program extracted on the memory is cleared from the memory through self-clearing. In this way, only data extracted through decoding from the self-decoding type encrypted file can be taken out, without any self-decoding execution program left on the memory.

Concerning a personal identification key, for example, if the contract number+date+serial number is determined beforehand as a personal identification key during conclusion of the secrecy agreement between transmitting and receiving sides, the attached encrypted file can be decoded only by the licensee who knows the personal identification key, enabling data distribution faster and more assuredly than confirmation of a counterpart via registered mail. This may also be used for the distribution of data for joint-venture type jobs that require secrecy.

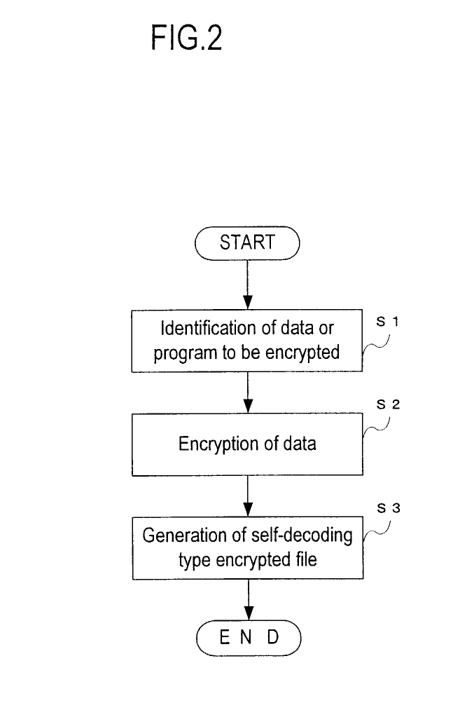

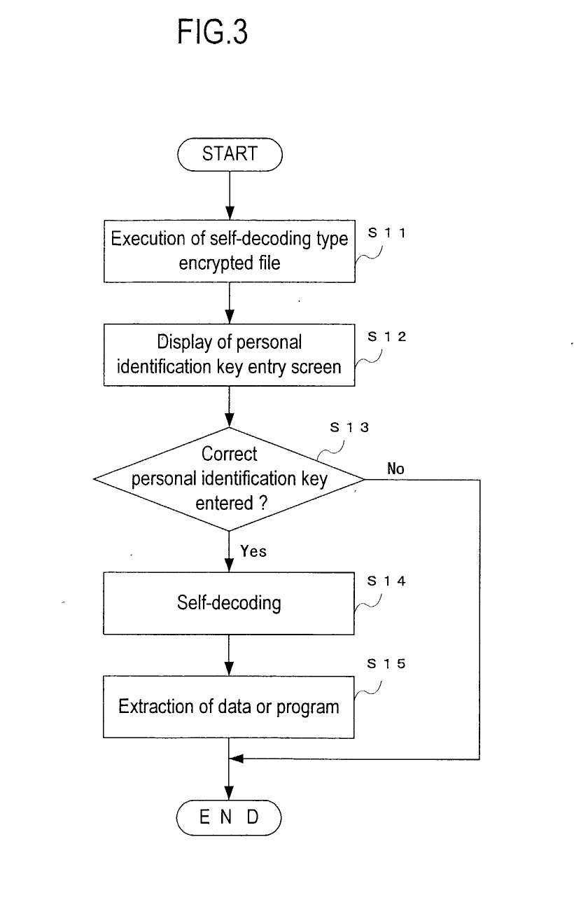

Next, processing of this file is described with reference made to FIGS. 2 and 3 specifically. FIG. 2 shows a flow chart showing processing in the control of transmitting PC. FIG. 3 shows the flow chart showing processing in the control of receiving PC.

As shown in FIG. 2, data or a program to be encrypted is identified at start of encryption of data with an installed encryption program on the transmitting side PC1, associating it to a self-decoding execution program (S1).

Then, data, etc. is encrypted with a personal identification key (S2), and a self-decoding type encrypted file in which the self-decoding execution program and encrypted data are integrated is generated (S3).

The self-decoding type encrypted file is a file (module) in which the encrypted data is integrated with the self-decoding execution program, both being indistinguishable apparently, and the encrypted data cannot be extracted by the method other than the legal decoding method.

As shown in FIG. 3, the receiving side PC2 receives electronic mail and opens a self-decoding type encrypted file of attached file through double-clicking, etc., executing said file (S11).

Then, a program stored in the self-decoding type encrypted file runs, displaying the pop-up window (personal identification key entry screen) to demand the entry of the personal identification key (S12). This program displays the personal identification key entry screen and hands the entered personal identification key to the self-decoding execution program. It is also possible to cause the self-decoding execution program to display the personal identification key entry screen and to take the personal identification key.

When a correct personal identification key is entered in the personal identification key entry screen (Yes), a self-decoding execution program runs to perform self-decoding (S14). With running of the self-decoding program, the program is extracted on the memory of PC2, decoding the enclosed encrypted data.

If the correct personal identification key is not entered (No), the processing is over and the encrypted data is not decoded.

Self-decoding is performed on encrypted data or an encrypted program by the processing S14 to extract decoded data or a program (S15). After the extraction of the data or the like has been completed, a self-decoding execution program developed on the memory is either self-cleared or cleared by another program present in the self-decoding type encrypted file. Therefore, once the extraction of the data or the like has been completed, there is no possibility that the self-decoding execution program is separated and left.

According to the use of this file, data encryption is made using a licensed encryption program on a transmitting PC1 and, at the same time, a self-decoding type encryption file containing the self-decoding execution program retained integrally with the encrypted data is prepared, and the above self-decoding type encryption file is transmitted to a receiving side PC2 where the received self-decoding type encryption file is started to run, demanding the entry of a personal identification key and the self-decoding execution program is started at the entry of a legal personal identification key, decodes the encrypted data, therefore, enabling decoding of the encrypted data even when the decoding program is not installed in the receiving side PC2, thereby improving the convenience of both data transmitting and receiving persons.

Moreover, according to this file, decoding of encrypted data is made in a receiving side PC2, followed by clearing of a self-decoding execution program, so that only required data is extracted after decoding and the decoding module is not left in the receiving side PC2. Namely, the transmitting side distributes, on its own responsibility, the self-decoding file from which only the encrypted data is extracted on the receiving side, effectively facilitating transaction of encrypted data.

The present invention is concerned with a self-decoding encrypted file for integrally retaining a decoding execution program for decoding associated encrypted information and the encrypted information, wherein when an operation of opening the file is done, the entry of personal identification information is demanded, and when the legal personal identification information is entered in response to the demand, the decoding execution program decodes the associated encrypted information. Therefore, even when a decoding program is not installed in a device, the encrypted information can be decoded by executing, based on the personal identification information, the decoding execution program retained integrally with the encrypted information. Accordingly, the decoding of the encrypted information can easily be performed, which makes it possible to improve convenience.

Furthermore, the present invention is concerned with a utilization method of a self-decoding type encrypted file comprising the steps of encrypting information by a transmitting side device to generate a self-decoding encrypted file integrally retaining the thus encrypted information and a decoding execution program for decoding the encrypted information; transmitting the file; performing an operation of opening the received self-decoding type encrypted file by a receiving side device to demand the entry of personal identification information; and entering the personal identification information to decode the encrypted information in accordance with the decoding execution program and to extract the information. Therefore, even when a decoding program is not installed in the receiving side device, the decoding execution program retained integrally with the encrypted information can be executed by the use of the personal identification information to decode the encrypted information. Accordingly, the decoding of the encrypted information can easily be performed, which makes it possible to improve convenience.

What is claimed is:

1. A self-decoding encrypted file for integrally retaining a decoding execution program which decodes associated encrypted information and the encrypted information, wherein when an operation of opening the file is done, the entry of personal identification information is demanded, and when the legal personal identification information is entered in response to the demand, the decoding execution program decodes the encrypted information.

2. The self-decoding encrypted file according to claim 1, wherein during the decoding, the program is developed and operated on a memory of a device which the decoding execution program executes, and when the decoding has been completed, the program developed on the memory is cleared.

3. A utilization method of a self-decoding type encrypted file comprising the steps of:
encrypting information by a transmitting side device to generate a self-decoding encrypted file integrally retaining the thus encrypted information and a decoding execution program for decoding the encrypted information;
transmitting the file;
performing an operation of opening the received self-decoding type encrypted file by a receiving side device to demand the entry of personal identification information; and
entering the personal identification information to decode the encrypted information in accordance with the decoding execution program and to extract the information.

4. The utilization method of the self-decoding encrypted file according to claim 3, wherein during the decoding in the receiving side device, the decoding execution program is developed and operated on a memory of the device which the decoding execution program executes, and when the decoding has been completed, the program developed on the memory is cleared.
